(19) United States
(12) Patent Application Publication
(10) Pub. No.: US 2026/0333038 A1
(43) Pub. Date: Oct. 22, 2026

(54) SIGNAL PROCESSING SYSTEM, MONITORING APPARATUS AND SIGNAL PROCESSING METHOD

(71) Applicant: REALTEK SEMICONDUCTOR CORP., HsinChu (TW)

(72) Inventors: Wen-Yung Lee, HsinChu (TW); Syu-Min Cyu, HsinChu (TW); Hsin-Hong Chou, HsinChu (TW)

(73) Assignee: REALTEK SEMICONDUCTOR CORP., HsinChu (TW)

(21) Appl. No.: 19/640,745

(22) Filed: Apr. 7, 2026

Related U.S. Application Data
(60) Provisional application No. 63/785,166, filed on Apr. 8, 2025.

(30) Foreign Application Priority Data
Mar. 30, 2026 (TW) 115112573

(51) Int. Cl. H04W 12/06; H04W 24/02

(52) U.S. Cl. CPC H04W 12/06; H04W 24/02

(57) ABSTRACT

A signal processing system includes a receiving module, a storage module, and a processing module. The receiving module is configured to receive a wireless signal. The wireless signal includes authentication information and training information. The storage module is configured to store a smoothing parameter. The processing module is coupled to the receiving module. The processing module is configured to: (a) obtain the corresponding smoothing parameter from the storage module according to the authentication information; (b) obtain first channel state information by performing channel estimation according to the training information; (c) obtain second channel state information by performing smoothing processing on the first channel state information according to the smoothing parameter; and (d) generate sensing information according to the second channel state information.

### CROSS-REFERENCE TO RELATED APPLICATION

This application claims the benefit of US provisional application serial No., 63/785,166 filed on Apr. 8, 2025 and claims the priority of Patent Application No. 115112573 filed in Taiwan, R.O.C. on Mar. 30, 2026. The entirety of the above-mentioned patent applications are hereby incorporated by references herein and made a part of the specification.

### BACKGROUND

### Technical Field

The present invention relates to a signal processing system, a monitoring apparatus, and a signal processing method.

### Related Art

Regarding health care and care of seniors, there is currently a location tracking watch for seniors, which uses Wi-Fi signals to sense their activities at home.

However, since Wi-Fi signals easily penetrate walls, multipath effects cause the receiver to receive long-range reflected signals. As a result, the sensing measurement report (SMR) includes excessive channel information from non-target areas, making the measurement results overly sensitive. Without effective filtering, the false detection rate (e.g., mistakenly identifying objects in neighboring rooms as targets) will increase. This filtering currently needs to be implemented in software at the application layer, resulting in a waste of processor resources.

### SUMMARY

In some embodiments, the present invention provides a signal processing system, including a receiving module, a storage module, and a processing module. The receiving module is configured to receive a wireless signal. The wireless signal includes authentication information and training information. The storage module is configured to store a smoothing parameter. The processing module is coupled to the receiving module. The processing module is configured to: (a) obtain the corresponding smoothing parameter from the storage module according to the authentication information; (b) obtain first channel state information by performing channel estimation according to the training information; (c) obtain second channel state information by performing smoothing processing on the first channel state information according to the smoothing parameter; and (d) generate sensing information according to the second channel state information.

In some embodiments, the processing module includes a physical layer module and a media access control layer module. The physical layer module transmits the wireless signal to the media access control layer module. The physical layer module is configured to execute steps (b), (c), and (d). The media access control layer module is configured to execute step (a).

In some embodiments, the processing module includes a smoothing filter module. When executing step (c), the physical layer module controls the smoothing filter module to obtain the second channel state information by performing smoothing processing on the first channel state information according to the smoothing parameter.

In some embodiments, the signal processing system further includes a transmission module, configured to receive a command signal transmitted by the receiving module and transmit the wireless signal according to the command signal. The command signal includes the authentication information.

In some embodiments, the present invention provides a monitoring apparatus, including a transmission module, a receiving module, a storage module, and a processing module. The transmission module is configured to be worn by a person and transmit a wireless signal. The wireless signal includes authentication information and training information. The receiving module is configured to receive a wireless signal. The storage module is configured to store a smoothing parameter. The processing module is coupled to the receiving module. The processing module is configured to: (a) obtain the corresponding smoothing parameter from the storage module according to the authentication information; (b) obtain first channel state information by performing channel estimation according to the training information; (c) obtain second channel state information by performing smoothing processing on the first channel state information according to the smoothing parameter; and (d) generate sensing information according to the second channel state information. (e) obtain a sensing result by analyzing the sensing information.

In some embodiments, the processing module includes a physical layer module, a media access control layer module, and an application layer module. The physical layer module transmits the wireless signal to the media access control layer module. The physical layer module is configured to execute steps (b), (c), and (d). The media access control layer module is configured to execute step (a). The application layer module is configured to execute step (e).

In some embodiments, the application layer module adjusts the smoothing parameter and stores the adjusted smoothing parameter in the storage module.

In some embodiments, the processing module includes a physical layer module, a media access control layer module, and an application layer module. The physical layer module transmits the wireless signal to the media access control layer module. The media access control layer module transmits the wireless signal and an execution instruction to the application layer. The application layer is configured to execute steps (a), (b), (c), (d), and (e).

In some embodiments, the present invention provides a signal processing method, including: receiving a wireless signal, the wireless signal including authentication information and training information; obtaining a smoothing parameter according to the authentication information; obtaining first channel state information by performing channel estimation according to the training information; obtaining second channel state information by performing smoothing processing on the first channel state information according to the smoothing parameter; and generating sensing information according to the second channel state information.

According to some embodiments of the present invention, by storing a plurality of smoothing parameters in the storage module, the processing module has clear smoothing guidance when performing smoothing processing on the wireless signal. Consequently, excessive multipath interference (e.g., long-range reflection) from non-target areas can be reduced, thereby significantly improving the area specificity and reliability of sensing.

### BRIEF DESCRIPTION OF THE DRAWINGS

FIG. 1 shows a schematic architectural diagram of a signal processing system in an embodiment of the present invention;

FIG. 2 shows a flowchart of a signal processing method in an embodiment of the present invention; and

FIG. 3 shows a schematic architectural diagram of a signal processing system in an embodiment of the present invention.

### DETAILED DESCRIPTION

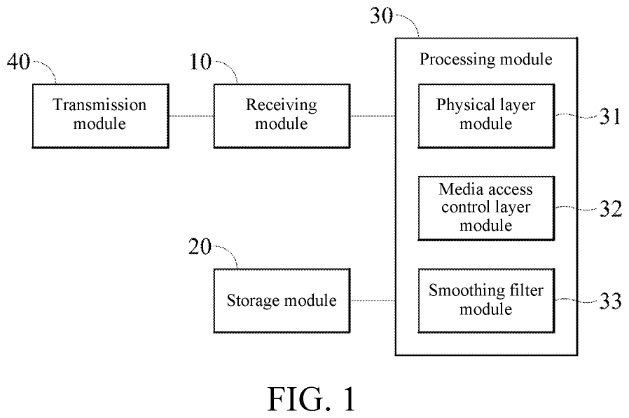

Referring to FIG. 1, an embodiment of the present invention provides a signal processing system, including a receiving module 10, a storage module 20, and a processing module 30.

Referring to FIG. 1, the receiving module 10 is configured to receive a wireless signal (step S01). The wireless signal includes authentication information and training information. The training information includes a high-efficiency long training field (HE-LTF) or an extremely high throughput long training field (EHT-LTF). In some embodiments, the wireless signal is a Wi-Fi signal. In some embodiments, the authentication information is a sensing ID or related identification information. The sensing ID is a string used for uniquely identifying a sensing device or a sensing operation.

The receiving module 10 receives the wireless signal transmitted from a transmission module 40. In some embodiments, the receiving module 10 communicates with the transmission module 40 in an active mode. Therefore, the transmission module 40 transmits a null data packet announcement (NDPA) according to a negotiation phase such that the receiving module 10 predicts transmitter information and the authentication information in advance. Next, the transmission module 40 transmits a null data packet (NDP) again. The null data packet includes authentication information and training information.

In some embodiments, the receiving module 10 communicates with the transmission module 40 in a passive mode. Therefore, the receiving module 10 first transmits a control frame to the transmission module 40. The control frame includes the authentication information. After receiving the control frame, the transmission module 40 generates a null data packet to the receiving module 10 according to the authentication information in the control frame. In this embodiment, the receiving module 10 may identify the transmission module 40 in advance, conforming to the definition of Sensing Measurement Parameters in the IEEE 802.11bf standard.

In some embodiments, the transmission module 40 is a signal transmission circuit (e.g., a signal transmission chip), configured to transmit a wireless signal. The receiving module 10 is a signal receiving circuit (e.g., a signal receiving chip), configured to receive the wireless signal.

Referring to FIG. 1, the storage module 20 is configured to store a smoothing parameter. In some embodiments, the storage module 20 stores a plurality of smoothing parameters, each of which corresponds to respective authentication information. In some embodiments, the storage module 20 may be a hardware component having read, write, and storage functions, such as, but not limited to, a non-volatile memory, a flash memory, a register, or a hard disk. The smoothing parameters include a filter width and a smoothing range.

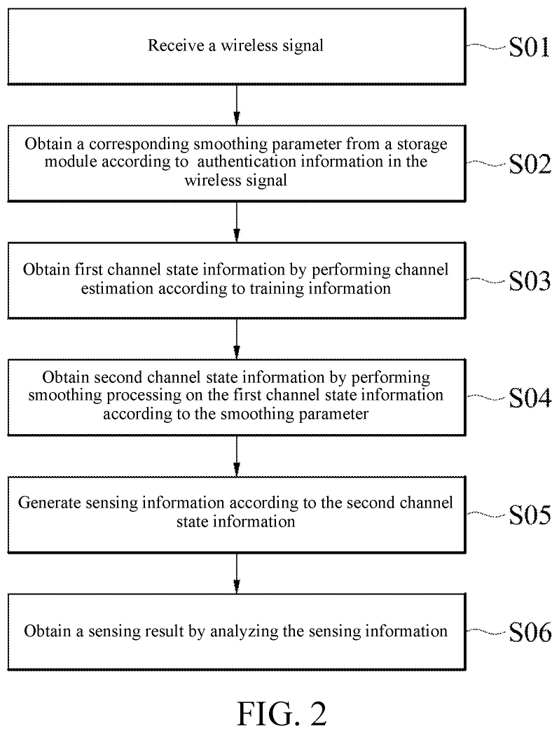

Referring to FIG. 1 and FIG. 2, the processing module 30 is coupled to the receiving module 10. In some embodiments, the processing module 30 may be a computing device such as a processor or a digital signal processor (DSP). The processing module 30 executes a signal processing method shown in FIG. 2.

As shown in FIG. 2, the processing module 30 receives a wireless signal from the receiving module 10 (step S01), and then obtain the corresponding smoothing parameter from the storage module 20 according to the authentication information in the wireless signal (step S02). The processing module 30 obtains first channel state information by performing channel estimation on the training information (step S03). In some embodiments, the processing module 30 performs channel estimation on the training information by using a least squares method. The processing module 30 obtains second channel state information by performing smoothing processing on the first channel state information according to the smoothing parameter (step S04). The processing module 30 generates sensing information according to the second channel state information (step S05). In some embodiments, the sensing information is a sensing measurement report (SMR), and the processing module 30 generates the sensing information in the form of an SMR including a header and the second channel state information. In some embodiments, the processing module 30 determines, according to settings, whether to encrypt the sensing information.

Based on the embodiments shown in FIG. 1 and FIG. 2 above, by storing the plurality of smoothing parameters in the storage module 20, the processing module 30 has clear smoothing guidance when performing smoothing processing on the wireless signal. Consequently, excessive multipath interference (e.g., long-range reflection) from non-target areas can be reduced, thereby significantly improving the area specificity and reliability of sensing.

In some embodiments, the processing module 30 includes a physical layer module 31 and a media access control layer module 32. The physical layer module 31 is coupled to the receiving module 10 and the media access control layer module 32 respectively. The physical layer module 31 transmits the wireless signal to the media access control layer module 32. The media access control layer module 32 is configured to execute step S02. Therefore, in this embodiment, after the receiving module 10 receives the wireless signal, the media access control layer module 32 obtains the authentication information according to the wireless signal, and then obtains the corresponding smoothing parameter from the storage module 20 according to the authentication information. The physical layer module 31 is configured to execute steps S03, S04, and S05. Therefore, in this embodiment, the physical layer module 31 obtains the first channel state information by performing channel estimation according to the training information, obtains the second channel state information by performing smoothing processing on the first channel state information according to the smoothing parameter, and generates the sensing information according to the second channel state information.

In some embodiments, after obtaining the smoothing parameter, the media access control layer module 32 transmits the smoothing parameter to the physical layer module 31 via a MAC/PHY interface. After receiving the smoothing parameter, the physical layer module 31 first latches the smoothing parameter. Only after completing step S03, the physical layer module 31 executes step S04 according to the smoothing parameter. This ensures precise timing, thereby conforming to the specification for a physical layer service interface (27.2 HE PHY Service Interface) in IEEE 802.11bf.

In some embodiments, the processing module 30 includes a smoothing filter module 33. When executing step S04, the physical layer module 31 controls the smoothing filter module 33 to obtain second channel state information by performing smoothing processing on the first channel state information according to the smoothing parameter. In some embodiments, the smoothing filter module 33 is a smoothing filter circuit or a functional module running smoothing filter calculations in a processor.

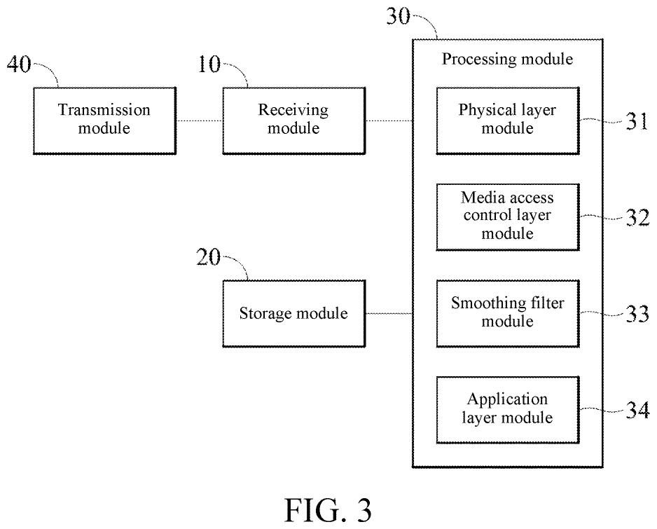

Referring to FIG. 3 and FIG. 2, in some embodiments, the signal processing system in the aforementioned embodiments is applied in a monitoring apparatus, and can implement various sensing applications, such as security monitoring and anti-theft, health care and care of seniors, smart homes and energy conservation, and gesture recognition and human-computer interaction. The monitoring apparatus includes a transmission module 40, a receiving module 10, a storage module 20, and a processing module 30. The transmission module 40 is configured to be worn by a person and transmit a wireless signal. For the operating methods and specific embodiments of the transmission module 40, the receiving module 10, the storage module 20, and the processing module 30, reference may be made to the aforementioned signal processing system. The processing module 30 obtains a sensing result by analyzing the sensing information (step S06). In some embodiments, the monitoring apparatus is used for health care and care of seniors, and the sensing information includes a location of a senior in a room. Therefore, after analyzing the sensing information, the processing module 30 may detect a state of the senior in the room, which serves as the sensing result.

In some embodiments, the processing module 30 includes a physical layer module 31, a media access control layer module 32, and an application layer module 34. The physical layer module 31 is coupled to the receiving module 10. The media access control layer module 32 is coupled to the physical layer module 31 and the application layer module 34 respectively. The physical layer module 31 transmits the wireless signal to the media access control layer module 32. The media access control layer module 32 is configured to execute step S02. The physical layer module 31 is configured to execute steps S03 to S05. The application layer module 34 is configured to execute step S06. In this embodiment, steps S03 to S05 are executed by the physical layer module 31 to reduce the load of the application layer module 34.

In some embodiments, the application layer module 34 adjusts the smoothing parameter and stores the adjusted smoothing parameter in the storage module 20. In this way, the monitoring apparatus may adjust the smoothing parameter according to actual conditions to improve the monitoring result. In some embodiments, the application layer module 34 determines whether to adjust the smoothing parameter according to a true positive rate (TPR) or a false positive rate (FPR) required by the application layer.

In some embodiments, the monitoring apparatus uses the application layer module 34 to execute most of the steps. In this embodiment, after the receiving module 10 receives the wireless signal, the physical layer module 31 transmits the wireless signal to the media access control layer module 32. The media access control layer module 32 transmits the wireless signal and an execution instruction to the application layer module 34. The application layer module 34 is configured to execute steps S02 to S06.

According to the sensing result obtained from steps S01 to S06, the monitoring apparatus can implement various sensing applications, such as security monitoring and anti-theft, health care and care of seniors, smart homes and energy conservation, and gesture recognition and human-computer interaction.

What is claimed is:

1. A signal processing system, comprising:
a receiving module, configured to receive a wireless signal, the wireless signal comprising authentication information and training information;
a storage module, configured to store a smoothing parameter; and
a processing module, coupled to the receiving module, wherein the processing module is configured to:
(a) obtain the corresponding smoothing parameter from the storage module according to the authentication information;
(b) obtain first channel state information by performing channel estimation according to the training information;
(c) obtain second channel state information by performing smoothing processing on the first channel state information according to the smoothing parameter; and
(d) generate sensing information according to the second channel state information.

2. The signal processing system according to claim 1, wherein the processing module comprises a physical layer module and a media access control layer module; the physical layer module transmits the wireless signal to the media access control layer module, and the physical layer module is configured to execute steps (b), (c), and (d); and the media access control layer module is configured to execute step (a).

3. The signal processing system according to claim 2, wherein the processing module comprises a smoothing filter module; and when executing step (c), the physical layer module controls the smoothing filter module to obtain the second channel state information by performing smoothing processing on the first channel state information according to the smoothing parameter.

4. The signal processing system according to claim 1, further comprising a transmission module, configured to receive a command signal transmitted by the receiving module and transmit the wireless signal according to the command signal, wherein the command signal comprises the authentication information.

5. A monitoring apparatus, comprising:
a transmission module, configured to be worn by a person and transmit a wireless signal, the wireless signal comprising authentication information and training information;
a receiving module, configured to receive the wireless signal;
a storage module, configured to store a smoothing parameter; and
a processing module, coupled to the receiving module, wherein the processing module is configured to:
(a) obtain the corresponding smoothing parameter from the storage module according to the authentication information;
(b) obtain first channel state information by performing channel estimation according to the training information;
(c) obtain second channel state information by performing smoothing processing on the first channel state information according to the smoothing parameter;
(d) generate sensing information according to the second channel state information; and
(e) obtain a sensing result by analyzing the sensing information.

6. The monitoring apparatus according to claim 5, wherein the processing module comprises a physical layer module, a media access control layer module, and an application layer module; the physical layer module transmits the wireless signal to the media access control layer module; the physical layer module is configured to execute steps (b), (c), and (d); the media access control layer module is configured to execute step (a); and the application layer module is configured to execute step (e).

7. The monitoring apparatus according to claim 6, wherein the processing module comprises a smoothing filter module, and when executing step (c), the physical layer module controls the smoothing filter module to obtain the second channel state information by performing smoothing processing on the first channel state information according to the smoothing parameter.

8. The monitoring apparatus according to claim 7, wherein the application layer module adjusts the smoothing parameter and stores the adjusted smoothing parameter in the storage module.

9. The monitoring apparatus according to claim 5, wherein the transmission module is configured to receive a command signal transmitted by the receiving module and transmit the wireless signal according to the command signal, wherein the command signal comprises the authentication information.

10. The monitoring apparatus according to claim 5, wherein the processing module comprises a physical layer module, a media access control layer module, and an application layer module; the physical layer module transmits the wireless signal to the media access control layer module; and the media access control layer module transmits the wireless signal and an execution instruction to the application layer module, and the application layer module is configured to execute steps (a), (b), (c), (d), and (e).

11. A signal processing method, comprising:
receiving a wireless signal, the wireless signal comprising authentication information and training information;
obtaining a corresponding smoothing parameter according to the authentication information;
obtaining first channel state information by performing channel estimation according to the training information;
obtaining second channel state information by performing smoothing processing on the first channel state information according to the smoothing parameter; and
generating sensing information according to the second channel state information.

12. The signal processing method according to claim 11, wherein the smoothing parameter is adjusted, and the adjusted smoothing parameter is stored.

13. The signal processing method according to claim 11, wherein a sensing result is obtained by analyzing the sensing information.
